(19) United States
(12) Patent Application Publication
(10) Pub. No.: US 2026/0336415 A1
(43) Pub. Date: Oct. 29, 2026

(54) METHOD FOR DETERMINING OUTPUT DATA FROM SENSOR DATA DETECTED BY AN OPTICAL SENSOR SYSTEM AND CONTROL MODULE OF A VEHICLE

(71) Applicants: CARIAD SE, Wolfsburg (DE); ROBERT BOSCH GMBH, Stuttgart (DE)

(72) Inventors: Matthias JUNGMANN, Wolfsburg (DE); Roman STUERTZ, Wolfsburg (DE); Alessandro MONTESI, Wolfsburg (DE)

(73) Assignees: CARIAD SE, Wolfsburg (DE); ROBERT BOSCH GMBH, Stuttgart (DE)

(21) Appl. No.: 19/660,472

(22) Filed: Apr. 28, 2026

(30) Foreign Application Priority Data
Apr. 28, 2025 (DE) 10 2025 116 169.0

(51) Int. Cl. B60K 35/90; G06T 7/262; G06T 7/73

(52) U.S. Cl. CPC B60K 35/90; G06T 7/262; G06T 7/75; B60K 2360/175; G06T 2207/10016; G06T 2207/20048; G06T 2207/20084

(57) ABSTRACT

A method of determining output data from sensor data detected by an optical sensor system during the drive of a vehicle may include detecting two environmental images as two two-dimensional raster images of an image sequence offset in time in an image processing stage. A raster image or a feature image of the image sequence is converted into a transformation image related to a reference plane by a geometric homography transformation. The transformation image and a non-converted reference image of the image sequence are processed by a neural network, such that a modified optical flow is determined. The modified optical flow, a geometric structural parameter, a relative position of the optical sensor system between the two two-dimensional raster images and a normal vector for an image point of a raster image among the two two-dimensional raster images are output by the neural network as output data.

### CROSS-REFERENCE TO RELATED APPLICATIONS

This application claims the priority benefit of German Patent Application No. 10 2025 116 169.0 filed on Apr. 28, 2025, which is incorporated by reference herein in its entirety.

### BACKGROUND

### 1. Field

An invention according to described examples may relate to a method for determining output data from sensor data detected by an optical sensor system.

### 2. Description of the Related Art

For certain purposes of application, it is required or desirable to extract in a capturing range detected by an optical sensor system, based on the detected sensor data of the optical sensor system, certain information contained therein as output data or to derive certain output data from it and then to provide this output data for further processing.

This is in particular relevant in assistance systems employed in vehicles for controlling the driving operation of the vehicle and thereby for assisting or relieving the driver of the vehicle in certain driving situations or in certain movement processes of the vehicle, since these assistance systems often require information with respect to the traffic space around the vehicle for ensuring their functioning and correspondingly process it. For example, this is the case in assistance systems of a vehicle formed as lane keeping assist, overtaking assist, turning assist, congestion assist, parking assist or distance assist for longitudinal control of the vehicle. To this end, these assistance systems can in particular also be employed in an assisted driving mode of the vehicle or in an automated driving mode of the vehicle or in an autonomous driving mode of the vehicle.

### SUMMARY

The invention according to the examples is based on an example object to specify a method for determining output data from sensor data detected by an optical sensor system, in which the generation and output of different output data by processing of the sensor data of the optical sensor system is allowed in an advantageous manner with high variability.

According to the examples of the invention, this example object may be solved by a method for determining output data from sensor data detected by an optical sensor system with the features recited in the claims.

Advantageous developments of the method according to the examples of the invention and a control module of a vehicle for performing the method are constituent of the further claims.

In the method according to the examples of the invention, in successive method sections (image processing stages), an image sequence of each two environmental images detected by an optical sensor system of a vehicle, processed by image transformation and related to a reference plane is processed by a single neural network using relative position information for the optical sensor system in a respective method section (process stage), from which various output variables are generated as output data independently of each other using a modified optical flow.

In particular, in the method according to the examples of the invention, for determining the output data from sensor data detected by an optical sensor system, camera images of a camera arranged in a vehicle as optical sensor data are detected as two-dimensional raster images of raster cells in successive method sections during the drive of the vehicle. Hereto, the optical sensor system or the camera can be moved in various directions, in particular also be forwards and/or rearwards and/or laterally moved.

In a respective method section, two environmental images in an image sequence are detected as two-dimensional raster images of raster cells or image points or pixels during the drive of the vehicle offset in time and thereby one after the other. An original image or initial image as one of the two environmental images or raster images of this image sequence or as a feature image, which has been obtained by processing one of the two environmental images or raster images of this image sequence, is transformed or converted into a transformation image as a transformation raster image or as a transformation feature image by a geometric homography transformation as an image transformation with respect to a reference plane. By this two-dimensional geometric homography transformation or image transformation, thus, various perspectives are established for the two raster images of an image sequence or for the two feature images of an image sequence in that one of the two raster images of the image sequence from the two raster images detected one after the other or one of the two feature images of the image sequence is transformed into the transformation raster image or into the transformation feature image as if the raster cells or image points or pixels of the transformation raster image or of the transformation feature image would look at a preset reference plane for the non-transformed raster image or non-transformed feature image representing a reference image and thereby a reference raster image or a reference feature image.

By the geometric homography transformation as the image transformation, thus, a virtual perspective to a reference plane is taken from the two environmental images of an image sequence from two raster images detected one after the other, such that the image points on the reference plane are at the same location for the transformation image as for the reference image detected offset in time. Since the image points on the reference plane accordingly do not change during an image sequence of two successively detected raster images or during an image sequence of two feature images, a significant stabilization of the image sequence and a simplification of the movement between the image points of the two raster images of an image sequence or of the two feature images of an image sequence is achieved, which in turn simplifies the processing of the raster images of the image sequence or of the feature images of the image sequence. Hereby, the optical flow or a modified optical flow can in particular also be determined in significantly simplified manner based on the related image points in the two raster images of an image sequence or in the two feature images of an image sequence.

As illustrated, this simplification of the movement is realized either upon application of the geometric homography transformation as the image transformation to an original image or initial image as a raster image of an image sequence or realized upon application of the geometric homography transformation as the image transformation to an original image or initial image as a feature image obtained by processing of one of the two raster images or environmental images of an image sequence.

Herein, the road plane of the road traveled during the drive of the vehicle is in particular used as the reference plane, since a movement of the image points on the road plane does not occur after application of the geometric homography transformation and it can thus be used as a constant reference variable.

Within the scope of the geometric homography transformation as the image transformation, the first one of the two original images is in particular converted into the transformation image in a respective image sequence of the two original images and the second one of the two original images is used as a non-transformed reference image. However, this association of the two original images of a respective image sequence can also be inversely performed. This means that in this case, in a respective image sequence, the second original image is converted into the transformation image and the first original image in a respective image sequence is used as the non-transformed reference image. In the individual successive method sections of the method according to the examples of the invention, the thus performed association of the two original images of an image sequence is then maintained with respect to the association with the transformation image and with the reference image for all of the respective method sections.

Thus, this approach applies in analogous manner if an application of the geometric homography transformation to one of the two raster images of an image sequence detected one after the other is performed or if an application of the geometric homography transformation to one of the two feature images obtained by processing of the raster images of an image sequence is performed.

This image sequence with the two environmental images detected one after the other offset in time during the drive of the vehicle as two-dimensional raster images of raster cells or image points or pixels is processed by a neural network, preferably by a neural network comprising a pyramidal network architecture with multiple processing levels.

Within the scope of the application of the geometric homography transformation to one of the two raster images or environmental images of an image sequence or within the scope of the application of the geometric homography transformation to one of the two feature images of an image sequence, for this, the spatial movement data of the optical sensor system determined based on the movement data of the vehicle within the scope of odometry between the time-offset detection of the two raster images of an image sequence as well as the relative position of the optical sensor system with respect to the reference plane determined upon the detection of a respective raster image of an image sequence for calibration of the optical sensor system are also supplied to the neural network with the preferably pyramidal network architecture.

To this end, the position of the optical sensor system with respect to the reference plane is indicated in an approximate representation, in particular in a four-dimensional representation by the three spatial coordinates and additionally the yaw angle of the vehicle or in a three-dimensional representation by the three spatial coordinates or in an estimated and thereby potentially erroneous position indication by the three spatial coordinates and three spatial angles of the vehicle. In particular, the approximate position indication of the optical sensor system is effected based on the capture of the normal vector of the reference plane and the height of the image points of a respective raster image with respect to the reference plane.

Within the scope of this extrinsic calibration of the optical sensor system, thus, a statement is in particular made about where the optical sensor system with respect to the reference plane is installed in the vehicle. Besides this extrinsic calibration of the optical sensor system, an intrinsic calibration with respect to the optical properties of the optical sensor system can also be performed, for example by determination of the installation situation of the optical sensor in the optical sensor system.

Based on the transformation image and the reference image of an image sequence and thereby based on the transformation raster image and the reference raster image of an image sequence or based on the transformation feature image and the reference feature image of an image sequence, a modified optical flow is processed from it and output by the neural network with the preferably pyramidal network architecture. The processing of the input data is thus performed by a single neural network with the pyramidal network architecture, and a modified optical flow is determined from it by the neural network as a virtual movement between the two raster images of an image sequence or between the two feature images of an image sequence of the two raster images of an image sequence or of the two feature images of an image sequence.

From it, in particular the following output variables are cumulatively or alternatively output by the neural network: the modified optical flow, a geometric structural parameter, the relative position of the optical sensor system between the two raster images of an image sequence preferably in a six-dimensional representation and a normal vector for each image point of the raster images.

The structural parameter used for calculating certain further output variables is determined as a representation of the three-dimensional representation in particular based on a homography matrix used in application of the geometric homography transformation. In particular, the structural parameter is a measure of the height of an image point with respect to the reference plane and can be used together with the depth of a respective image point with respect to the optical center of the optical system in particular for three-dimensional reconstruction of the reference image.

The exact and in particular six-dimensional relative position indication of the optical sensor system between the two environmental images of an image sequence and thereby the spatial orientation of the optical sensor system in the vehicle and the positioning thereof with respect to the reference plane in comparison between the two environmental images of an image sequence includes the yaw angle, the roll angle and the pitch angle in a six-dimensional representation as indications in addition to the three spatial coordinates. Therein, the yaw angle is a measure of the rotation of the optical sensor system about the vertical axis thereof, the roll angle is a measure of the rotation of the optical sensor system about the longitudinal axis thereof and the pitch angle is a measure of the rotation of the optical sensor system about the transverse axis thereof.

In an advantageous development of the method, a parallax transformation with respect to the reference plane is performed as the geometric homography transformation by the homography matrix for transformation of one of the two original images of an image sequence into the transformation image. This means that, based on a geometric transformation by a virtual parallax, image points of one of the two original images of an image sequence are correspondingly shifted using the homography matrix.

This homography matrix established based on the reference plane and the odometry data of the vehicle as an abstract simplified representation of the environment of the vehicle based on a virtual parallax thus includes a geometric assumption about the reference plane or road plane and the image points of the two environmental images of an image sequence.

In particular, based on the virtual parallax transformation as the homography transformation performed by the homography matrix within the scope of the processing performed by the neural network, the structural parameter can then be determined as needed and output or be utilized for corresponding cases of application and be used for further applications.

In a further advantageous development of the method, the optical flow between the two environmental images of an image sequence is determined from the modified optical flow by an inverse transformation of the transformation image into the original initial image performed by the structural parameter. This optical flow is a characteristic variable for the movement of the vehicle and can be utilized for corresponding cases of application and be used for further applications.

In a further advantageous development of the method, a three-dimensional reconstruction of one of the two environmental images of an image sequence and for this in particular a three-dimensional reconstruction of the reference image of an image sequence is performed by the structural parameter. Within the scope of this three-dimensional reconstruction, a calculation of height and depth of the image points of this reference image is effected based on the structural parameter and the normal vector to the reference plane. This three-dimensional representation of the reference image can then be utilized for corresponding cases of application and be used for further applications.

The normal vector for each image point of the raster images as a starting variable can be used for the three-dimensional representation of the two environmental images of an image sequence, but in particular also for calibration of the optical system, preferably for the calibration of a camera of the vehicle as the optical system. In the latter case of the calibration of a camera of the vehicle, a suitable normal vector of a certain image point of one of the raster images can preferably be utilized for this.

By the neural network preferably comprising a pyramidal network architecture with multiple hierarchically arranged processing levels, in a respective method section, the reference image and the transformation image of an image sequence are successively processed at the individual processing levels, wherein a resolution different from processing level to processing level and a different information content are associated with the reference image and the transformation image of an image sequence.

Thus, different properties or characteristic features of the reference image and of the transformation image are used at every processing level with a different detail accuracy with respect to the resolution thereof. For this, by the neural network with the pyramidal network architecture, in the successive method steps of a method section, in downscaling first effected at the consecutive descending processing levels, a processing of the reference image and of the transformation image of an image sequence is performed in network layers with successively lower resolution and successively higher information content. In upscaling subsequent hereto, the information generated by the neural network is then again provided based on an increasingly higher resolution at the consecutive ascending processing levels.

This means that in a respective method section, at the consecutive descending processing levels, the resolution of the reference image and of the transformation image of an image sequence is first successively reduced by downscaling and the information content of the reference image and of the transformation image of an image sequence is successively increased in particular based on property channels or image channels, wherein the reference image and the transformation image of an image sequence are correspondingly processed and fused at a respective processing level. Subsequently, at the consecutive ascending processing levels, based on upscaling, the contents of processed and fused reference image and transformation image of an image sequence are successively provided. Hereby, the first coarse estimation in the processing and fusion of reference image and transformation image of an image sequence is successively refined by more and more supplied contents and information. For example, during downscaling at the consecutive descending processing levels, the number of the raster cells or image points considered for the respective reference image and transformation image of an image sequence is successively halved, while the number of the property channels or image channels used for the respective reference image and transformation image of an image sequence as the information content is successively increased at the same time.

As already described, in the presented method, the two raster images of an image sequence cannot only be processed as an "image" itself, but based on the contents contained in the raster images and characteristic properties or features in the form of feature images derived from the raster images. To this end, the properties or features of the two raster images of an image sequence are analyzed by an encoder and relevant image properties or features of a respective raster image are stored as a so-called feature map in the feature images. For example, the edges contained in a respective raster image of an image sequence are used as the relevant image properties or features of a respective raster image. In the successively consecutive method steps of a method section, the homography matrix used for the geometric homography transformation is then applied to one of the two feature images at the respective processing level, whereby the properties or features thereof are then correspondingly transformed.

At a respective processing level, a fusion of reference image and transformation image is then performed preferably by a correlation method as a so-called cross-attention method. In particular, in a local cross-attention method, the relations between individual image points of reference image and transformation image of an image sequence in a local neighborhood are determined based on a matrix operation, whereby the similarities between the individual image points of reference image and transformation image of an image sequence are in particular also ascertained.

For controlling the method according to the examples of the invention and the method sections of the method according to the examples of the invention and thereby for controlling the method sequence, a control module or control device can be provided, by which the control of the optical sensor system and the neural network for processing and evaluating the optical sensor data is performed.

The components for performing the method according to the examples of the invention, in particular a control module or control device, a neural network and an optical sensor system, can be configured as separate members of a vehicle and be arranged networked in the vehicle to this end. Alternatively hereto, individual or all components of the control module or control device can also be arranged modularly combined in a common member in a vehicle.

A vehicle employed in the application of the method according to the examples of the invention can in particular be formed as a motor vehicle or automobile, as a passenger car or as a truck or as a motorcycle or as a passenger bus.

In particular, the vehicle can also be operated in an assisted driving mode and/or in an automated driving mode and/or in an autonomous driving mode.

The invention according to the examples also includes the combinations of the features of the described examples. Thus, the invention according to the examples also includes realizations, which each comprise a combination of the features of multiple of the described examples if the examples have not been described as mutually exclusive.

With the method according to the examples of the invention, diverse output data can be extracted from sensor data captured by an optical sensor system of a vehicle in an advantageous manner with high accuracy and provided for further processing.

### BRIEF DESCRIPTION OF DRAWINGS

In the following, examples of the invention are described. Hereto, there shows:

FIG. 1 is a schematic block diagram with components and functional units for the method according to an example of the invention,

FIG. 2 is views of image representations used for the method according to an example of the invention during a method section according to a first example of the method,

FIG. 3 is a schematic representation for explaining the method sequence during a method section according to a second example of the method.

### DESCRIPTION

The examples explained in the following are examples of the invention. In the examples, the described components each represent individual features of examples of the invention to be considered independently of each other, which also each develop the invention according to the examples independently of each other and thereby are also to be regarded as a constituent of the invention according to the examples in individual manner or in a combination different from the shown one. Furthermore, the described examples can also be supplemented by further ones of the already described features of examples of the invention.

In the figures, functionally identical elements are each provided with the same reference characters.

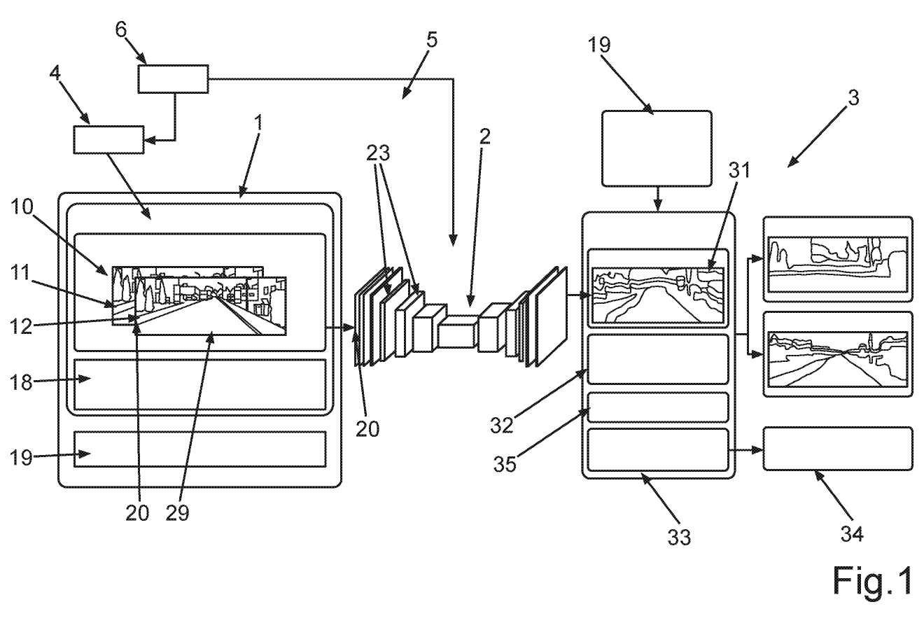

According to FIG. 1, it can be seen that a single neural network 2 with a certain pyramidal network architecture and consecutive processing levels 23 for processing various input data 1 is provided in the method according to the examples of the invention. This input data 1 is successively processed at the individual processing levels 23 of the neural network 2 in consecutive method steps (image processing stages), from which different output data 3 is then generated and output according to case of application and optionally provided to corresponding applications for further processing.

After training of the neural network 2 effected in a training phase based on training data as the input data 1, the method according to the examples of the invention is then employed during the drive of a vehicle 5. The vehicle 5 comprises a control module 6, which controls the neural network 2 and the optical sensor system 4 of the vehicle 5 for example formed as a camera. In an example, the control module or control device 6 may be implemented by a computer processor communicationally coupled to a memory, and configured to execute the method according to the examples of the invention. Hereto, in successively consecutive method sections during the drive of the vehicle 5, optical sensor data is detected as two-dimensional raster images 11, 12 of raster cells or image points or pixels by the camera 4 of the vehicle 5 in the capturing range in the traffic space around the vehicle 5. This optical sensor data of the raster cells or image points or pixels for example present as color values or RGB values can be transformed into an information range with information values. Hereby, at least one characteristic information or a property is also associated with each raster cell of a raster image 11, 12 as a feature besides an index value localizing its position in the capturing range, such that corresponding feature images are hereby generated.

In particular, in a respective method section, two environmental images are detected offset in time as two-dimensional raster images 11, 12 of an image sequence 10, wherefrom two corresponding feature images can then also be derived. This means, in successively consecutive method sections, two raster images 11, 12 of an image sequence 10 detected in a certain capturing range offset in time one after each other by the camera 4 of the vehicle 5 are in particular also supplied to the neural network 2 as the input data 1 during a respective method section. The two raster images 11, 12 of an image sequence 10 are for example detected with a frequency of 25 Hz and thereby in a temporal spacing of 40 ms by the camera 4 of the vehicle 5, this means that the second raster image 12 of an image sequence 10 is detected by the camera 4 of the vehicle 5 respectively 40 ms after the first raster image 11 of the image sequence 10.

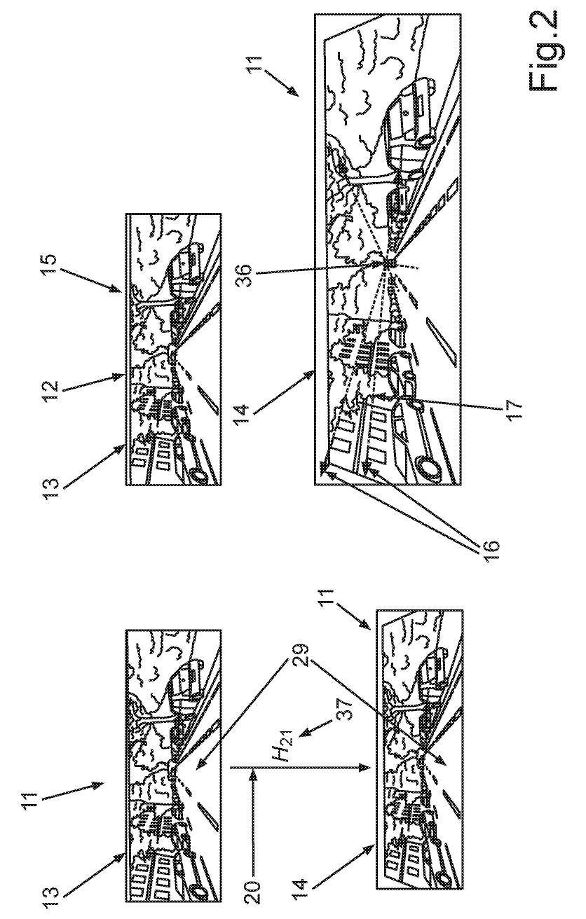

As can in particular also be seen in FIG. 2, according to a first example of the invention, one of the two raster images 11, 12 of the image sequence 10 is converted from the original image 13 into a transformation image 14 by a geometric homography transformation 20 using a homography matrix 37 and thereby transformed into a transformation raster image and the other one of the two raster images 11, 12 of the image sequence 10 in contrast is not transformed and thus this original image 13 is used as a non-converted reference image 15 and thereby as a reference raster image. In an example, the respective second raster image 12 of an image sequence 10 is used as a non-converted reference image 15 or as a reference raster image and thereby not transformed and thus this original image 13 is left unchanged, while the respective first raster image 11 of an image sequence 10 is transformed using the homography matrix 37, for example using a 3 x 3 matrix as the homography matrix 37, from the original image 13 into a transformation image 14 and thereby converted into the transformation raster image 14. By this geometric homography transformation 20 of the first raster image 11 of an image sequence 10, it is achieved that the two raster images 11, 12 of an image sequence 10 look at the same image points of the reference plane 29 thus virtually remained unchanged despite of the movement of the vehicle 5 during the time-offset detection of the two raster images 11, 12 of an image sequence 10.

The geometric homography transformation 20 performed for this by the homography matrix 37 as a parallax transformation related to the reference plane 29 is illustrated in more detail in the right lower image of FIG. 2. There, in the transformation image 14 obtained after the geometric homography transformation 20 as transformation raster image, the reference point of the homography transformation 20 as an epipole 36, the virtual parallax lines 17 originating from the epipole 36 and the virtual parallax vectors 16 are represented. Therein, the virtual parallax vectors 16 are a measure of the movement between the stabilized raster images 11, 12 of an image sequence 10 and form the basis for determining a geometric structural parameter 31 or transformation parameter.

Apart from that, the reference image 15 not transformed in a certain method section (image processing stage) in an image sequence 10 as the second raster image 12 is then transformed into a transformation image 14 in the temporally following method section (image processing stage) as the then first raster image 11 of this method section (image processing stage) in this method section (image processing stage) and thereby used as the transformation raster image there.

According to FIG. 1, the relative position data for the camera position 18 of the camera 4 during the detection of the two raster images 11, 12 of an image sequence 10 as well as calibration data relating to the orientation of the camera 4 for calibration 19 of the camera 4 are also supplied to the neural network 2 besides the two raster images 11, 12 of an image sequence 10 as input data 1.

The relative position data for the camera position 18 of the camera 4 is determined based on odometry data of the vehicle 5 and includes for example three-dimensional indications to the three spatial coordinates or four-dimensional indications to the three spatial coordinates and the yaw angle of the vehicle 5 characterizing the rotation about the vertical axis of the vehicle 5 during the detection of the two raster images 11, 12 of an image sequence 10 as a coarse and thereby potentially erroneous approximate indication.

As the calibration data for calibration 19 of the camera 4 and thereby for the orientation of the camera 4, the normal vector of the reference plane 29 with respect to the camera 4 and the respective height of the image points of the two raster images 11, 12 of an image sequence 10 with respect to the reference plane 29 are in particular ascertained.

According to case of application and purpose of employment of the method, the pyramidal neural network 2 can be trained for providing output data 3 suitable for the case of application and purpose of employment of the method and be correspondingly employed thereafter. This output data 3 generated by the pyramidal neural network 2 after processing the input data 1 can be alternatively or cumulatively provided by the neural network 2.

For example, after processing the two raster images 11, 12 of an image sequence 10, a geometric structural parameter 31 or transformation parameter is generated by the neural network 2 using calibration data for calibration 19 of the camera 4 and using the virtual parallax vectors 16 as the output data 3, six-dimensional exact position data for the relative camera position 18 of the camera 4 as well as the modified optical flow 33 as a measure of the movement between the two raster images 11, 12 of an image sequence 10 based on the transformation image 14 and the reference image 15. In particular, the geometric structural parameter 31 or transformation parameter can thus be determined using the calibration data for the calibration 19 and thereby for the orientation of the camera 4 as well as using the virtual parallax vectors 16. This structural parameter 31 or transformation parameter can be used for the reconstruction of three-dimensional environmental images from the two-dimensional raster images 11, 12 of an image sequence 10 in that the height and depth of the individual raster points of the two raster images 11, 12 of an image sequence 10 are calculated based on the structural parameter 31 or transformation parameter. Furthermore, the optical flow 34 can then be determined as a measure of the movement between the two raster images 11, 12 of an image sequence 10 based on an inverse transformation of the transformation image 14 into the original image 13 from the modified optical flow 33 using the structural parameter 31.

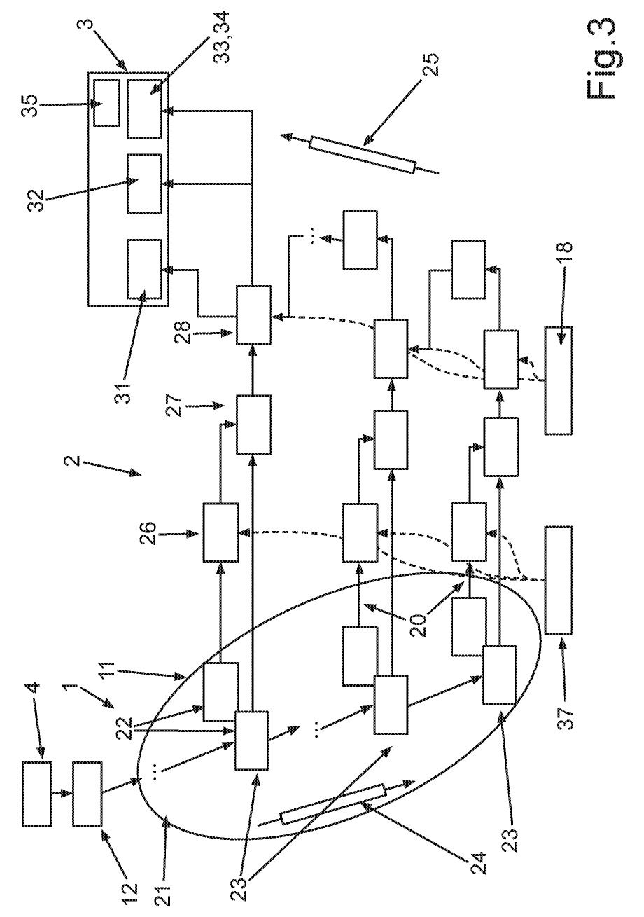

In FIG. 3, certain functional units of the neural network 2 according to a second example of the invention are schematically illustrated. Herein, the association of the functional units of the neural network 2 with the individual method steps illustrated according to FIG. 3 is to serve only for exemplification, since these functional units of the neural network 2 cannot be exactly delimited from each other in their association and thereby in their effect and task and individual functional units of the neural network 2 can also contribute in method steps different from those illustrated in FIG. 3.

As the input data 1, in particular the currently detected second raster image 12 of an image sequence 10 as an original image 13 and the buffered first raster image 11 of an image sequence 10 as the original image 13 are supplied to the neural network 2 comprising a pyramidal network architecture with multiple hierarchically structured processing levels 23. From these two raster images 11, 12 of an image sequence 10, information or features and thereby characteristic features contained in the two raster images 11, 12 are extracted by an encoder 21 and these derived features are associated with the two raster images 11, 12. These characteristic patterns in the two raster images 11, 12 of an image sequence 10 are stored in the two feature images 22. In successive method steps, these two feature images 22 are processed at respectively one of the processing levels 23 based on a respectively different scaling. Herein, a certain resolution and a certain information content are associated with the two feature images 22 of an image sequence 10 at a respective processing level 23 such that the two feature images 22 of an image sequence 10 are processed at different processing levels 23 with a different resolution and with a different information content. For example, within the scope of downscaling 24 of the processing levels 23, the resolution of the two feature images 22 is reduced, for example successively halved, at every following processing level 23, while the information content of the two feature images 22 of an image sequence 10 for example set based on information channels is increased at each following processing level 23. Thus, the two feature images 22 of an image sequence 10 are for example processed in two-dimensional representation at the first processing level 23 with full resolution with respect to height and width and with 3 information channels, that is for example with 1024 x 1024 image points of the respective feature image 22. At the next processing level 23, the two feature images 22 of an image sequence 10 are processed with a resolution half with respect to the first processing level 23 with respect to height and width and with 16 information channels, that is for example with 512 x 512 image points of the respective feature image 22. At the processing level 23 in turn following thereto, the two feature images 22 of an image sequence 10 are processed with a quarter of the resolution with respect to the height and width and with 32 information channels, that is for example with 256 x 256 image points of the respective feature image 22, and so on.

For example, four such processing levels 23 are associated with the neural network 2, in which the two feature images 22 are then correspondingly processed. For example, the first feature image 22 of an image sequence 10 is converted and thereby transformed into a transformation feature image as a transformation image 14 in a transformation step 26 by the homography transformation 20 using the homography matrix 37 at each of the processing levels 23.

Subsequently, this transformation feature image as the transformation image 14 is fused with the second feature image as the reference image 15 and thereby as a reference feature image in a fusion step 27 at each of the processing levels 23, in particular using a local cross-attention method as a special correlation method.

Subsequently, a basis for determining the geometric structural parameter 31 is provided at each of the processing levels 23 based on the supplied approximate position data for the camera position 18 of the camera 4 in an additional information processing step 28 with the aid of additional information.

The association or correlation of the two feature images 22 of an image sequence 10 obtained at a respective processing level 23 as well as the additional information obtained at a respective processing level 23 in the additional information processing step 28 for determining the geometric structural parameter 31 is successively transferred to the ascending processing levels 23 within the scope of upscaling 25.

Finally, the output data 3 adequate for the desired case of application of the method is then provided by the neural network 2 based on the results of one of the processing levels 23, in particular provided based on the results of the uppermost processing level 23. For example, the structural parameter 31, refined and thereby exact relative position data for the relative camera position 32 of the camera 4 in the vehicle 5, the modified optical flow 33, the optical flow 34 determined from it and a normal vector 35 per image point of the environmental images can be output as output data 3 by the neural network 2 and then be correspondingly further processed, for example be used by at least one assistance system of the vehicle for controlling driving tasks of the vehicle.

Thus, the examples overall show how, based on optical sensor data detected during the drive of a vehicle by an optical sensor system of the vehicle in a capturing range in the traffic space around the vehicle, a determination of output information required for the respective purpose of application can be advantageously variably performed.

A description has been provided with particular reference to examples, but it will be understood that variations and modifications can be effected within the spirit and scope of the claims, which may include the phrase "at least one of A, B and C" as an alternative expression that refers to one or more of A, B or C, contrary to the holding in Superguide v. DIRECTV, 358 F3d 870, 69 USPQ2d 1865 (Fed. Cir. 2004).

### LIST OF REFERENCE CHARACTERS

1 Input data
2 neural network
3 output data
4 optical sensor system/camera
5 vehicle
6 control module
10 image sequence
11 first raster image
12 second raster image
13 original image
14 transformation image
15 reference image
16 virtual parallax vector
17 virtual parallax line
18 approximate camera position
19 calibration
20 homography transformation
21 encoder
22 feature images
23 processing levels
24 downscaling
25 upscaling
26 transformation step
27 fusion step
28 additional information step
29 reference plane
31 structural parameter
32 detailed camera position
33 modified optical flow
34 optical flow
35 normal vector per image point
36 epipole
37 homography matrix

1. A method of determining output data from sensor data detected by an optical sensor system arranged in a vehicle, comprising:
by a control module configured with a computer processor configured to execute a process including,
obtaining the sensor data detected during a drive of the vehicle by the optical sensor system in successive image processing stages by the optical sensor system,
detecting two environmental images in form of two two-dimensional raster images in an image sequence offset in time in form of a time-offset during the drive of the vehicle in a respective image processing stage among the successive image processing stages,
converting an original image as one of the two two-dimensional raster images of the image sequence or as one of two feature images derived from the two two-dimensional raster images of the image sequence into a transformation image related to a reference plane by a geometric homography transformation and presenting the original image as other one of the two two-dimensional raster images of the image sequence or as other one of the two feature images derived from the two two-dimensional raster images of the image sequence as a non-converted reference image,
supplying the non-converted reference image and the transformation image to a neural network , the supplying including movement data of the optical sensor system based on movement data of the vehicle between the time-offset of the two two-dimensional raster images, and a relative position of the optical sensor system with respect to the reference plane determined in the two two-dimensional raster images for calibration of the optical sensor system,
such that
a modified optical flow is determined by the neural network by processing the non-converted reference image and the transformation image , and
the modified optical flow and/or a geometric structural parameter and/or the relative position of the optical sensor system between the two two-dimensional raster images and/or a normal vector for an image point of a raster image of the two two-dimensional raster images are output by the neural network as the output data.

2. The method according to claim 1, wherein
for the converting the original image into the transformation image, a parallax transformation with respect to the reference plane as a geometric homography transformation by a homography matrix is performed.

3. The method according to claim 1, wherein
an optical flow between the two two-dimensional raster images is determined from the modified optical flow.

4. The method according to claim 1, wherein
the two feature images are derived from the two two-dimensional raster images such that features of the two two-dimensional raster images are analyzed by an encoder and relevant features of a respective raster image of the two two-dimensional raster images are stored as an associated feature image among the two feature images.

5. The method according to claim 1, further comprising:
performing the calibration of the optical sensor system based on the normal vector with respect to the reference plane and based on a height indication with respect to the reference plane determined for the image point.

6. The method according to claim 1, further comprising performing a three-dimensional reconstruction of the non-converted reference image by a structural parameter.

7. The method according to claim 1, wherein
in the respective image processing stage, the non-converted reference image and the transformation image are processed by the neural network including a pyramidal network architecture with processing levels.

8. The method according to claim 7, wherein
a different resolution and a different information content are respectively associated with the non-converted reference image and the transformation image at the processing levels of the neural network.

9. The method according to claim 8, wherein
in the respective image processing stage, first, a resolution of the non-converted reference image and of the transformation image is successively reduced by downscaling in consecutive descending processing levels among the processing levels of the neural network and subsequently, information content of the non-converted reference image and of the transformation image is successively increased by upscaling in consecutive ascending processing levels among the processing levels of the neural network, such that the non-converted reference image and the transformation image are successively fused with each other at a respective processing level among the processing levels of the neural network.

10. The method according to claim 9, wherein
at the respective processing level among the processing levels of the neural network, a fusion of the non-converted reference image and of the transformation image is performed by a cross-attention method.

11. A control device of a vehicle with an optical sensor system, comprising:
a computer processor communicationally coupled to a memory and configured to execute a process including,
obtaining sensor data detected during a drive of the vehicle by the optical sensor system in successive image processing stages by the optical sensor system,
detecting two environmental images in form of two two-dimensional raster images in an image sequence offset in time in form of a time-offset during the drive of the vehicle in a respective image processing stage among the successive image processing stages,
converting an original image as one of the two two-dimensional raster images of the image sequence or as one of two feature images derived from the two two-dimensional raster images of the image sequence into a transformation image related to a reference plane by a geometric homography transformation and presenting the original image as other one of the two two-dimensional raster images of the image sequence or as other one of the two feature images derived from the two two-dimensional raster images of the image sequence as a non-converted reference image,
supplying the non-converted reference image and the transformation image to a neural network, the supplying including movement data of the optical sensor system based on movement data of the vehicle between the time-offset of the two two-dimensional raster images, and a relative position of the optical sensor system with respect to the reference plane determined in the two two-dimensional raster images for calibration of the optical sensor system,
such that
a modified optical flow is determined by the neural network by processing the non-converted reference image and the transformation image , and
the modified optical flow and/or a geometric structural parameter and/or the relative position of the optical sensor system between the two two-dimensional raster images and/or a normal vector for an image point of a raster image of the two two-dimensional raster images are output by the neural network as output data.
